(19) United States
(12) Patent Application Publication
(10) Pub. No.: US 2012/0163214 A1
(43) Pub. Date: Jun. 28, 2012

(54) APPARATUS AND METHOD FOR MEASURING VOICE QUALITY OF VoIP TERMINAL USING WIDEBAND VOICE CODEC

(75) Inventors: Woon-Seob So, Daejeon (KR); Do-Young Kim, Daejeon (KR); Byung-Sun Lee, Daejeon (KR)

(73) Assignee: Electronics and Telecommunications Research Institute, Daejeon (KR)

(21) Appl. No.: 13/333,502

(22) Filed: Dec. 21, 2011

(30) Foreign Application Priority Data
Dec. 23, 2010 (KR) 10-2010-0133988

(51) Int. Cl. H04W 24/00

(52) U.S. Cl. 370/252

(57) ABSTRACT

A method for measuring voice quality in a wireless communication network includes measuring an MOS of a signal using a narrowband voice codec and an MOS of a signal using a wideband voice codec in a cable loopback environment, calculating a wideband voice codec correction coefficient using the measured MOS, measuring an MOS of a signal using the narrowband voice codec and an MOS of a signal using the wideband voice codec in a terminal connection environment; and outputting a value obtained by adding the wideband voice codec correction coefficient to the measured MOS in the terminal connection environment.

### CROSS-REFERENCE TO RELATED APPLICATIONS

The present application claims priority of Korean Patent Application No. 10-2010-0133988, filed on Dec. 23, 2010, which is incorporated herein by reference in its entirety.

### BACKGROUND OF THE INVENTION

1. Field of the Invention

Exemplary embodiments of the present invention relate to an apparatus and method for measuring the voice quality of a VoIP terminal; and, more particularly, to an apparatus and method for measuring the voice quality of a VoIP terminal for providing high voice quality using a wideband voice codec.

2. Description of Related Art

Existing voice phones were developed based on a wired public switched telephone network (PSTN) and a mobile telephone network. However, with the rapid development of the Internet, Voice over Internet Protocol (hereinafter, referred to as a “VoIP”) communications for providing voice services through the Internet have come into the spotlight. VoIP is a technology that uses a packet switched network in which packet-based communications are performed. The VoIP has a lower stability than the circuit-based switching technology used in existing voice phone networks.

A variety of evaluation methods are used so as to evaluate voice communications. The voice quality evaluation method for measuring the voice quality of a voice phone is generally divided into an objective evaluation method using a measuring instrument and a subjective evaluation method for performing evaluation through a person's ear. A mean opinion score (hereinafter, referred to as an “MOS”) may be used in the subjective evaluation method. The MOS is frequently used as a unit for indicating a grade of voice quality or a reference for indicating the voice quality of a telephone by dividing a mean value of user's subjective evaluation into 5 grades. In the International Telecommunication Union (ITU), the MOS is used by extracting an “R value” based on a subjective numerical value such as a delay time and converting the R value into an MOS, so as to overcome the limitation of the MOS that is a subjective numerical value. Perceptual Analysis Measurement System (PAMS) and Perceptual Evaluation of Speech Quality (PESQ) are most frequently used as the objective evaluation method. Both the PAMS and PESQ uses a method for measuring a reference voice and a specific audio sample, provided through a communication system, receiving them at a reception terminal and comparing the receive voice with the original voice.

In order to achieve high-quality voice communications, a wideband voice codec is used for each VoIP terminal in a VoIP system. The wideband voice codec used in the VoIP system is G.722, G.711.1, G729.1, SILK, Speex, etc. In a subjective voice quality test, the voice quality of terminals in the VoIP system using the wideband voice codec tends to have performance higher than the voice quality of terminals in the VoIP system using a narrowband voice codec. This is because a signal used in the wideband voice codec has a voice bandwidth two times wider than that used in the narrowband voice codec.

When the narrowband voice codec is used, P.862.1 standard is used as the standard for voice quality measurement. When the wideband voice codec is used, P.862.2 standard is used as the standard for voice quality measurement in the wideband voice codec. However, if the voice quality of a VoIP terminal is measured by an apparatus for measuring the voice quality of the VoIP terminal when the wideband voice codec is used, the measured result of the voice quality according to the P.862.2 standard is remarkably lower than that of the voice quality according to the P.861.1 standard. The voice quality is measured according to each of the standards, but energy of a band lower or higher than a narrowband used in the VoIP system is relatively less than the narrowband. Hence, it is considered in the apparatus that many errors may occur in the apparatus.

However, in the subjective evaluation method, an MOS in the wideband voice codec is generally higher than that in the narrowband voice codec. Hence, it is expected that in the objective evaluation method, the MOS in the wideband voice codec is to be higher than that in the narrowband voice codec. Therefore, it is required to develop a technique for correcting a relatively high MOS.

### SUMMARY OF THE INVENTION

An embodiment of the present invention is directed to an apparatus and method for measuring the voice quality of a VoIP terminal, which can perform precise voice quality measurement.

Another embodiment of the present invention is directed to an apparatus and method for measuring the voice quality of a VoIP terminal, which can extract an objective voice quality value for indicating the voice quality.

Another embodiment of the present invention is directed to an apparatus and method for measuring the voice quality of a VoIP terminal, which can provide a stable VoIP service.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for measuring voice quality in a wireless communication network includes a mean opinion score (MOS) processing unit configured to extract an MOS of a signal using a narrowband voice codec and an MOS of signal using a wideband voice codec in a cable loopback environment, and extract an MOS of a signal using the narrowband voice codec and an MOS of a signal using the wideband voice codec in a terminal connection environment; a wideband codec correction unit configured to generate a wideband voice codec correction coefficient using the MOS of the signal using the narrowband voice codec, extracted in the cable loopback environment, and the MOS of the signal using the wideband voice codec, extracted in the cable loopback environment; and a result output unit configured to output, as a quality index of the voice quality, a value obtained by adding the wideband voice codec correction coefficient to the extracted MOS of the signal using the wideband voice codec, when the MOS is extracted in the terminal connection environment and the extracted MOS is the MOS of the signal using the wideband voice codec.

In accordance with an embodiment of the present invention, a method for measuring voice quality in a wireless communication network includes setting a cable loopback environment and measuring an MOS of a signal using a narrowband voice codec and an MOS of a signal using a wideband voice codec in the loopback environment; calculating a wideband voice codec correction coefficient using the measured MOS of the signal using the narrowband voice codec and the measured MOS of the signal using the wideband voice codec; setting a terminal connection environment and measuring an MOS of a signal using the narrowband voice codec and an MOS of a signal using the wideband voice codec in the terminal connection environment; and when the MOS measured in the terminal connection environment is an MOS of the signal using the wideband voice codec, outputting a value obtained by adding the wideband voice codec correction coefficient to the measured MOS of the signal using the wideband voice codec.

### BRIEF DESCRIPTION OF THE DRAWINGS

FIG. 1 is a conceptual diagram illustrating a technique for measuring the voice quality of a VoIP terminal in accordance with an embodiment of the present invention.

FIG. 2 is a conceptual diagram illustrating a technique for measuring voice quality in a cable loopback test in accordance with the embodiment of the present invention.

FIG. 3 is a block diagram illustrating a configuration of an apparatus for measuring the voice quality of a VoIP terminal using a wideband voice codec in accordance with the embodiment of the present invention.

FIG. 4 is a flowchart illustrating a method for measuring the voice quality of a VoIP terminal using a wideband voice codec in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Exemplary embodiments of the present invention relate to a technique in which a wideband voice codec correction unit is added to an existing apparatus for measuring voice quality, and a value corresponding to a voice quality index of a VoIP terminal using a narrowband voice codec in an objective voice quality measurement is outputted by correcting an MOS that is a voice quality value using a wideband voice codec correction coefficient extracted in a cable loopback test when measuring the voice quality of a VoIP terminal using a wideband voice codec, thereby comparing the measured voice qualities.

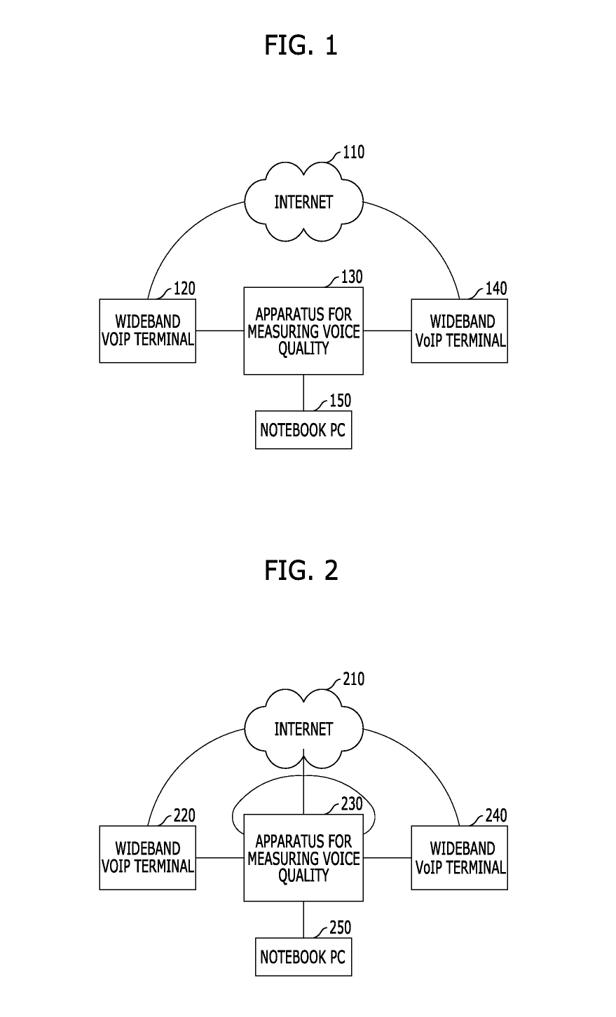

FIG. 1 is a conceptual diagram illustrating a technique for measuring the voice quality of a VoIP terminal in accordance with an embodiment of the present invention.

In FIG. 1, the technique is implemented using an internet network 110, wideband VoIP terminals 120 and 140 for providing a VoIP service using a wideband voice codec, an apparatus 130 for measuring voice quality and a terminal 150 for monitoring or controlling the apparatus 130.

Although a notebook PC is used as an example of the terminal 150 in FIG. 1, the present invention is not limited thereto. As occasion demands, the terminal 150 may be included in the apparatus 130.

A technique for measuring the voice quality of a VoIP terminal will be described in detail with reference to FIG. 1. FIG. 1 illustrates a schematic configuration for measuring the voice quality between the VoIP terminals 120 and 140 using the wideband voice codec through the internet network 110. The notebook PC 150 is connected to control the apparatus 130. The notebook PC 150 also controls setting of a configuration related to voice quality measurement, setting of various parameters, and the like.

When wired communication is implemented, the wideband VoIP terminals 120 and 140 refer to VoIP terminals that support not only the narrowband voice codec but also the wideband voice codec. In FIG. 1, one of the VoIP terminals 120 and 140 communicates with the other of VoIP terminals 120 and 140 through the internet network 110 using wired Ethernet. A part at which each of the VoIP terminals 120 and 140 is connected to the apparatus 130 may be set as a handset connection cable of each of the wideband VoIP terminals 120 and 140.

When wireless communication is implemented, the wideband VoIP terminals 120 and 140 are connected to the internet network 110 using an access point (hereinafter, referred to as an “AP”). In this case, a part at which each of the VoIP terminals 120 and 140 is connected to the apparatus 130 may be configured as a cable to which a microphone/earphone jack is connected.

If voice quality measurement is started after communication between the VoIP terminals 120 and 140 is set, the apparatus 130 transmits a test signal defined in a standard of measure to one-side terminal, and the one-side terminal receiving the test signal transmits the test signal to other-side terminal. This will be described as an example with reference to FIG. 1. The apparatus 130 transmits the test signal by the standard of measure to the one-side terminal (120 in FIG. 1), and the one-side terminal receiving the test terminal transmits the test terminal to the other-side terminal (140 in FIG. 1) using the internet network 120.

The apparatus 130 measures a signal-to-noise ratio (SNR) and delay by comparing the test signal received by the other-side terminal with the test signal generated and transmitted by the apparatus 130, and outputs the measured SNR and delay as an MOS. When the narrowband voice codec is used, a test signal having a sampling clock frequency of 8 kHz is used, and the MOS is calculated according to the P.861.1 standard. When the wideband voice codec is used, a test signal having a sampling clock frequency of 16 kHz is used, and the MOS is calculated according to the P.861.2 standard. In the apparatus, various output values can be obtained depending on the setting of measurement parameters.

FIG. 2 is a conceptual diagram illustrating a technique for measuring voice quality in a cable loopback test in accordance with the embodiment of the present invention.

In FIG. 2, the technique is implemented using an internet network 210, wideband VoIP terminals 220 and 240 for providing a VoIP service using a wideband voice codec, An apparatus 230 for measuring voice quality and a terminal 250 for monitoring or controlling the apparatus 230. Although a notebook PC is used as an example of the terminal 250 in FIG. 1, the present invention is not limited thereto. As occasion demands, the terminal 250 may be included in the apparatus 230.

The technique for measuring voice quality in a cable loopback test will be described in detail with reference to FIG. 2. In FIG. 2, before the voice quality is measured by connecting the VoIP terminals 220 and 240, a cable connected to a headset of the VoIP terminal is loopback-connected within the apparatus so as to measure a voice quality degradation value caused by the apparatus 230 and a voice quality degradation value caused by the use of the cable.

The maximum value of the MOS that is a voice quality index is generally 5.0, but voice quality degradation caused by hardware of the apparatus 230 and voice quality degradation caused by the use of the cable occur. In this case, a delay factor is very small, and hence it is possible to neglect the delay factor. However, the distortion of a signal occurs to an extent, and hence a voice quality reference value is necessarily obtained through the cable loopback test. Accordingly, it is possible to exactly measure a voice quality value additionally caused the use of the codec and the network.

For example, if a parameter for measuring the voice quality of a VoIP terminal using a narrowband voice codec is set and the MOS measured in the cable loopback test is 4.6, the MOS is measured as 4.2 obtained by basically subtracting 0.4 from 4.6 based on the maximum value 5.0. Therefore, if the MOS measured when the VoIP terminal is connected to the apparatus 230 is 4.1, the actual MOS is additionally degraded by 0.5, and the MOS based on 5.0 becomes 4.5 obtained by adding 0.4 to 4.1.

If a parameter for measuring the voice quality of a VoIP terminal using the wideband voice codec is set and the MOS measured in the cable loopback test is 3.8, the MOS is measured as 2.6 obtained by basically subtracting 1.2 from 3.8 based on the maximum value 5.0. Therefore, if the MOS measured when the VoIP terminal is connected to the apparatus 230 is 3.4, the actual MOS is additionally degraded by 0.4, and the MOS based on 5.0 becomes 4.6 obtained by adding 1.2 to 3.4. Accordingly, a basic voice quality degradation index for each of the uses of the narrowband voice codec and the wideband voice codec, caused by the cable loopback test, is obtained, and a relative voice quality value is measured using the voice quality degradation index so as to objectively measure the voice quality of the VoIP terminal using the narrowband voice codec and the voice quality of the VoIP terminal using the wideband voice codec using the apparatus 230 and relatively compare the measured voice qualities.

In order to correct the part decreased by the use of the wideband voice codec, 0.8 obtained by subtracting 3.8 from 4.6 based on the value measured in the cable loopback test for the purpose of conversion into a value of the narrowband voice codec becomes a wideband voice codec correction coefficient. Therefore, if 3.8 measured in the use of the wideband voice codec is converted to compared the value measured in the use of the wideband voice codec with that of the narrowband voice codec, the converted value becomes 4.2 obtained by adding 0.8 (wideband voice codec correction coefficient) to 3.4. That is, a case where a correction coefficient is extracted by comparing the value measured in the cable loopback test with the value measured in the use of the narrowband voice codec and the extracted correction coefficient is then added to the value measured in the use of the wideband voice codec is reflected so as to extract an exact comparison value when the precise wideband codec is used.

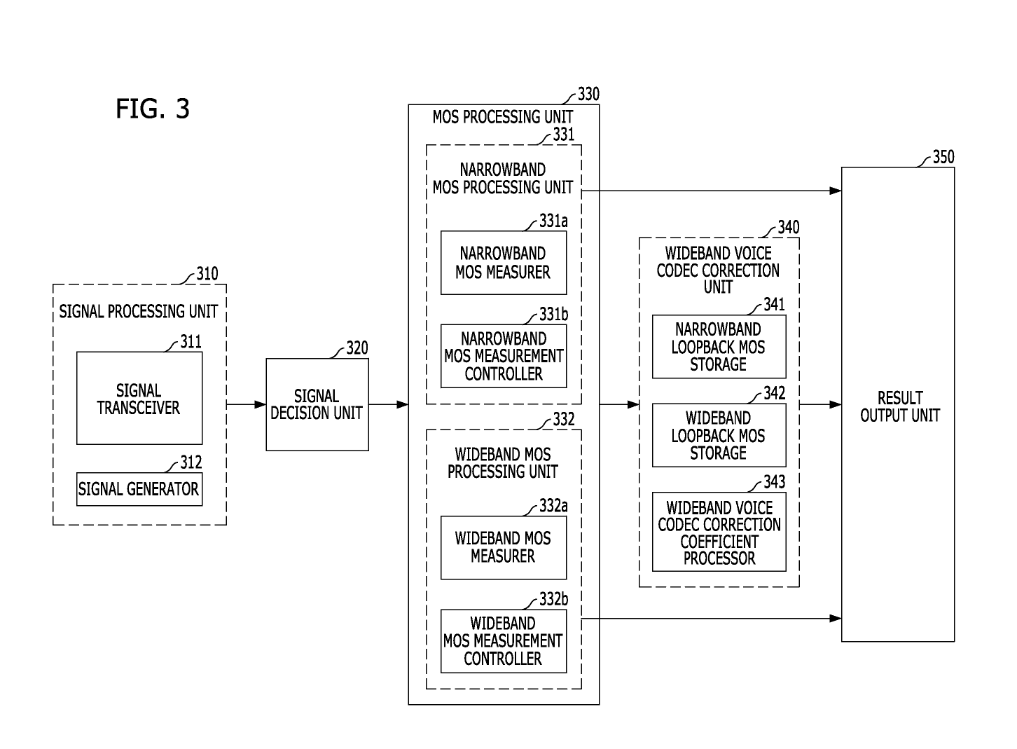

FIG. 3 is a block diagram illustrating a configuration of an apparatus for measuring the voice quality of a VoIP terminal using a wideband voice codec in accordance with the embodiment of the present invention.

In FIG. 3, the apparatus 230 includes a signal processing unit 310, a signal decision unit 320, an MOS processing unit 330, a wideband voice codec correction unit 340 and a result output unit 350. The signal processing unit 310 is composed of a signal transceiver 311 and a signal generator 312. The MOS processing unit 330 includes a narrowband MOS processing unit 331 and a wideband MOS processing unit 332. The wideband voice codec correction unit 340 is composed of a narrowband loopback MOS storage 341, a wideband loopback MOS storage 342 and a wideband voice codec correction coefficient processor 343. The narrow MOS processing unit 331 is composed of a narrowband MOS measurer 331a and a narrowband MOS measurement controller 331b. The wideband MOS processing unit 332 is composed of a wideband MOS measurer 332a and a wideband MOS measurement controller 332b.

An operation of the present invention in accordance with the embodiment of the present invention will be described in detail with reference to FIG. 3. The signal processing unit 310 generates a signal for measuring voice quality and transmits the generated signal so as to measure the voice quality. Then, the signal processing unit 310 receives a signal corresponding to the transmitted signal. The signal generator 312 of the signal processing unit 310 generates a signal defined in the standard and provides the generated signal to the signal transceiver 311 so as to measure the voice quality. The signal transceiver 311 of the signal processing unit 310 receives the signal generated by the signal generator 312 and transmits a signal for measuring the voice quality. Then, the signal transceiver 312 receives a signal corresponding to the transmitted signal and provides the received signal to the signal decision unit 320. In this case, the signals transmitted and received by the signal transceiver 311 are signals transmitted and received through actual VoIP terminals or signals transmitted and received using a cable loopback. Since both signals using the wideband voice codec and the narrowband voice codec may be used in the apparatus in accordance with the embodiment of the present invention, the signals transmitted and received by the signal transceiver 311 may be both the signals using the wideband voice codec and the narrowband voice codec.

The signal decision unit 320 decides whether the signal provided from the signal processing unit 310 is a signal using the narrowband voice codec or a signal using the wideband voice codec, and provides a signal to the MOS processing unit 330 based on the decided result. The MOS processing unit 330 extracts an MOS of the signal received from the signal decision unit 320 and provides the extracted MOS to the wideband voice codec correction unit 340 and the result output unit 350.

The narrowband MOS processing unit 331 of the MOS processing unit 330 operates when the signal provided from the signal decision unit 320 is a signal using the narrowband voice codec. The wideband MOS processing unit 332 of the MOS processing unit 330 operates when the signal provided from the signal decision unit 320 is a signal using the wideband voice codec.

The narrowband MOS measurer 331a of the narrowband signal processing unit 331 measures an MOS by comparing the signal generated by the signal generator 312 and the signal received by the signal transceiver 311. The narrowband MOS measurement controller 331b of the narrowband MOS processing unit 331 controls whether the MOS measured by the narrowband MOS measurer 331a is a signal measured using the cable loopback or a signal measured by connecting an actual VoIP terminal to the apparatus, and provides the measured MOS to the wideband voice codec correction unit 340 or the result output unit 350. That is, the narrowband MOS measurement controller 331b provides the measured MOS to the wideband voice codec correction unit 340 when the MOS measured by the narrowband MOS measurer 331a is an MOS of the signal measured using the cable loopback, and provides the measured MOS to the result output unit 350 when the MOS measured by the narrowband MOS measurer 331a is an MOS of the signal measured by connecting the actual VoIP terminal to the apparatus.

The wideband MOS measurer 332a of the wideband signal processing unit 332 measures an MOS by comparing the signal generated by the signal generator 312 and the signal received by the signal transceiver 311. The wideband MOS measurement controller 332b of the wideband signal processing unit 332 controls whether the MOS measured by the wideband MOS measurer 332a is a signal measured using the cable loopback or a signal measured by connecting an actual VoIP terminal to the apparatus, and provides the measured MOS to the wideband voice codec correction unit 340 or the result output unit 350. That is, the wideband MOS measurement controller 332b provides the measured MOS to the wideband voice codec correction unit 340 when the MOS measured by the wideband MOS measurer 332a is an MOS of the signal measured using the cable loopback, and provides the measured MOS to the result output unit 350 when the MOS measured by the wideband MOS measurer 332a is an MOS of the signal measured by connecting the actual VoIP terminal to the apparatus.

When the signal provided from the MOS processing unit 330 is a loopback signal, the wideband voice codec correction unit 340 calculates a wideband voice codec correction coefficient using the MOS. The narrowband loopback MOS storage 341 of the wideband voice codec correction unit 340 stores the MOS when the signal provided from the narrowband MOS processing unit 331 of the MOS processing unit 330 is a loopback signal. The wideband loopback MOS storage 342 of the wideband voice codec correction unit 340 stores the MOS when the signal provided from the wideband MOS processing unit of the MOS processing unit 330 is a loopback signal. The wideband voice codec correction coefficient processor 343 of the wideband voice codec correction unit 340 calculates a wideband voice codec correction efficient using the MOS stored in the narrowband loopback MOS storage 341 and the MOS stored in the wideband loopback MOS storage 432, and then provides the calculated correction efficient to the result output unit 350.

The result output unit 350 outputs a result of the voice quality using the MOS when the narrowband voice codec is used and the MOS when the wideband voice codec is used, which are provided from the MOS processing unit 330, and the wideband voice codec correction coefficient provided from the wideband voice codec correction unit 340. If the MOS provided from the MOS processing unit 330 is obtained when the narrowband voice codec is used, the result output unit 350 immediately outputs the MOS provided from the MOS processing unit 330. If the MOS provided from the MOS processing unit 330 is obtained when the wideband voice codec is used, the result output unit 350 outputs a value obtained by adding the wideband voice codec correction efficient provided from the wideband voice codec correction unit 340 to the MOS provided from the MOS processing unit 330.

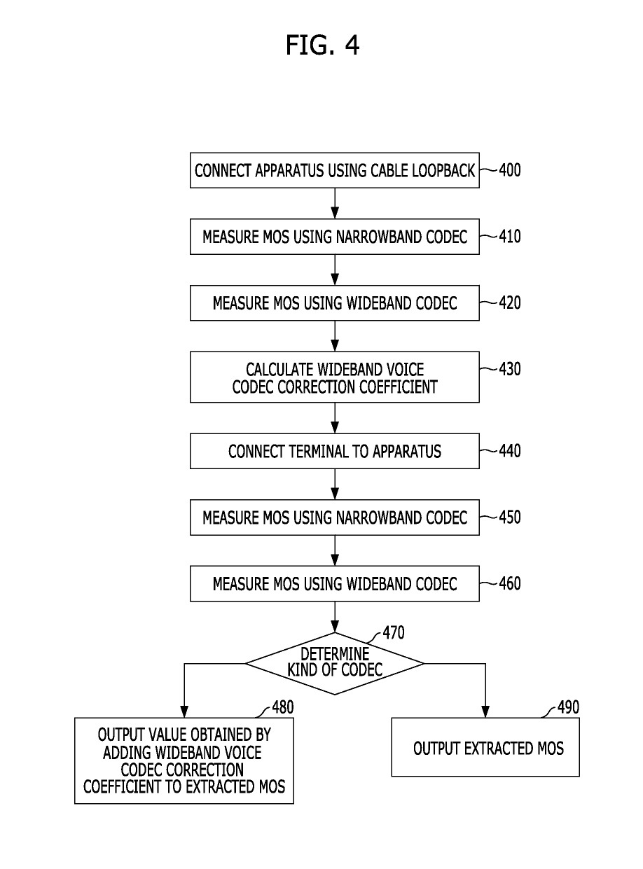

FIG. 4 is a flowchart illustrating a method for measuring the voice quality of a VoIP terminal using a wideband voice codec in accordance with an embodiment of the present invention.

At step 400, after the apparatus 230 is connected using a cable loopback, the signal processing unit 310 generates and transmits a test signal, and receives a signal corresponding to the transmitted signal. The received signal is a signal using a narrowband voice codec or a signal using a wideband voice codec. At step 410, the MOS processing unit 330 measures an MOS when the signal received at the step 400 is a signal using the narrowband voice codec. At step 420, the MOS processing unit 330 measures an MOS when the signal received at the step 400 is a signal using the wideband voice codec. The order of the steps 410 and 420 is not determined but is determined by the received signal. At step 430, the wideband voice codec correction unit 340 calculates a wideband voice codec correction coefficient using the MOS measured using the narrowband voice codec at the step 410 and the MOS measured using the wideband voice codec at the step 420.

At step 440, the cable loopback is removed from the apparatus 230, and an actual VoIP terminal is connected to the apparatus 230. Then, the signal processing unit 310 transmits a signal for measuring voice quality and receives a signal corresponding to the transmitted signal. The received signal is a signal measured using the narrowband voice codec or a signal measured using the wideband voice codec. At step 450, the MOS processing unit 330 measures an MOS when the signal received at the step 440 is a signal using the narrowband voice codec. At step 460, the MOS processing unit 330 measures an MOS when the signal received at the step 440 is a signal using the wideband voice codec. The order of the steps 450 and 460 is not determined but is determined by the received signal.

At step 470, the result output unit 350 determines whether the signal received at the step 440 is a signal using the narrowband voice codec or a signal using the wideband voice codec. At step 480, the result output unit 350 outputs, as a voice quality index, a value obtained by adding the wideband voice codec correction coefficient to the MOS measured at the step 460, when the signal received at the step 440 is a signal using the wideband voice codec. At the step 470, the result output unit 350 outputs the MOS measured at the step 450 as it is, when the signal received at the step 440 is a signal using the narrowband voice codec.

In the apparatus for measuring voice quality in accordance with the embodiment of the present invention, a wideband voice codec correction unit is added to the existing apparatus for measuring voice quality, and a value corresponding to a voice quality index of a VoIP terminal using a narrowband voice codec in an objective voice quality measurement is outputted by correcting an MOS that is a voice quality value using a wideband voice codec correction coefficient extracted in a cable loopback test when measuring the voice quality of a VoIP terminal using a wideband voice codec, thereby comparing the measured voice qualities.

In accordance with the exemplary embodiments of the present invention, it is possible to perform precise voice quality measurement, to extract an objective voice quality value and to provide a stable VoIP service.

While the present invention has been described with respect to the specific embodiments, it will be apparent to those skilled in the art that various changes and modifications may be made without departing from the spirit and scope of the invention as defined in the following claims.

What is claimed is:

1. An apparatus for measuring voice quality in a wireless communication network, the apparatus comprising:
a mean opinion score (MOS) processing unit configured to extract an MOS of a signal using a narrowband voice codec and an MOS of signal using a wideband voice codec in a cable loopback environment, and extract an MOS of a signal using the narrowband voice codec and an MOS of a signal using the wideband voice codec in a terminal connection environment;
a wideband codec correction unit configured to generate a wideband voice codec correction coefficient using the MOS of the signal using the narrowband voice codec, extracted in the cable loopback environment, and the MOS of the signal using the wideband voice codec, extracted in the cable loopback environment; and
a result output unit configured to output, as a quality index of the voice quality, a value obtained by adding the wideband voice codec correction coefficient to the extracted MOS of the signal using the wideband voice codec, when the MOS is extracted in the terminal connection environment and the extracted MOS is the MOS of the signal using the wideband voice codec.

2. The apparatus of claim 1, wherein, when the MOS is extracted in the terminal connection environment and the extracted MOS is the MOS of the signal using the narrowband voice codec, the result output unit outputs the extracted MOS of the signal unit the narrowband voice codec as a quality index of the voice quality.

3. The apparatus of claim 1, further comprising:
a signal processing unit configured to generate a signal for measuring the voice quality, transmit the generated signal to the cable loopback environment and the terminal connection environment, and receive a signal corresponding to the transmitted signal; and
a signal decision unit configured to decide whether the signal received by the signal processing unit is a signal using the narrowband voice codec or a signal using the wideband voice codec.

4. The apparatus of claim 3, wherein the signal processing unit comprises:
a signal generator configured to generate a signal for measuring the voice quality so as to be suitable for each standard; and
a signal transceiver configured to transmit the generated signal to the cable loopback environment and the terminal connection environment, and receive a signal corresponding to the transmitted signal.

5. The apparatus of claim 1, wherein the MOS processing unit comprises:
a narrowband MOS processing unit configured to, when the received signal is a signal using the narrowband voice codec in the cable loopback environment or the terminal connection environment, extract an MOS of the signal using the narrowband voice codec; and
a wideband MOS processing unit configured to, when the received signal is a signal using the wideband voice codec in the cable loopback environment or the terminal connection environment, extract an MOS of the signal using the wideband voice codec.

6. The apparatus of claim 5, wherein the narrowband MOS processing unit comprises:
a narrowband MOS measurer configured to, when the signal received by the signal transceiver is a signal using the narrowband voice codec, measure an MOS by comparing the signal generated by the signal generator and the signal received by the signal transceiver; and
a narrowband MOS measurement controller configured to, when the MOS measured by the narrowband MOS measurer is an MOS measured in the cable loopback environment, provide the measured MOS to the wideband voice codec correction unit.

7. The apparatus of claim 6, wherein, when the MOS measured by the narrowband MOS measurer is an MOS measured in the terminal connection environment, provide the MOS measured by the narrowband MOS measurer to the result output unit.

8. The apparatus of claim 5, wherein the wideband MOS processing unit comprises:
a wideband MOS measurer configured to, when the signal received by the signal transceiver is a signal using the wideband voice codec, measure an MOS by comparing the signal generated by the signal generator and the signal received by the signal transceiver; and
a wideband MOS measurement controller configured to, when the MOS measured by the wideband MOS measurer is an MOS measured in the cable loopback environment, provide the measured MOS to the wideband voice codec correction unit.

9. The apparatus of claim 8, wherein, when the MOS measured by the wideband MOS measurer is an MOS measured in the terminal connection environment, the wideband MOS measurement controller provides the MOS measured by the wideband MOS measurer to the result output unit.

10. The apparatus of claim 1, wherein the wideband voice codec correction unit comprises:
a narrowband loopback MOS storage configured to store an MOS in the cable loopback environment, provided from the narrowband MOS processing unit;
a wideband loopback MOS storage configured to store an MOS in the cable loopback environment, provided from the wideband MOS processing unit; and
a wideband voice codec correction coefficient processor configured to calculate a wideband voice codec correction coefficient using the MOS stored in the narrowband loopback MOS storage and the MOS stored in the wideband loopback MOS storage.

11. The apparatus of claim 10, wherein the wideband voice codec correction coefficient is a value obtained by subtracting the MOS stored in the wideband loopback MOS storage from the MOS stored in the narrowband loopback MOS storage.

12. The apparatus of claim 1, wherein the cable loopback environment is configured so that only input/output terminals of the apparatus are loopback-connected through a cable without connecting the terminal to the apparatus.

13. A method for measuring voice quality in a wireless communication network, the method comprising:
setting a cable loopback environment and measuring an MOS of a signal using a narrowband voice codec and an MOS of a signal using a wideband voice codec in the loopback environment;
calculating a wideband voice codec correction coefficient using the measured MOS of the signal using the narrowband voice codec and the measured MOS of the signal using the wideband voice codec;
setting a terminal connection environment and measuring an MOS of a signal using the narrowband voice codec and an MOS of a signal using the wideband voice codec in the terminal connection environment; and
when the MOS measured in the terminal connection environment is an MOS of the signal using the wideband voice codec, outputting a value obtained by adding the wideband voice codec correction coefficient to the measured MOS of the signal using the wideband voice codec.

14. The method of claim 13, further comprising, when the MOS measured in the terminal connection environment is an MOS of the signal using the narrowband voice codec, outputting the measured MOS of the signal using the narrowband voice codec as it is.

15. The method of claim 13, wherein the wideband voice codec correction coefficient is a value obtained by subtracting the MOS of the signal using the wideband voice codec, measured in the cable loopback environment, from the MOS of the signal using the narrowband voice codec, measured in the cable loopback environment.

16. The method of claim 13, wherein the cable loopback environment is configured so that only input/output terminals of the apparatus are loopback-connected through a cable without connecting the terminal to the apparatus.
